(19) United States
(12) Patent Application Publication
(10) Pub. No.: US 2025/0309759 A1
(43) Pub. Date: Oct. 2, 2025

(54) FILTER DEVICE

(71) Applicant: DENSO CORPORATION, Kariya-city (JP)

(72) Inventor: Yoshihide FUKUDA, Kariya-city (JP)

(73) Assignee: DENSO CORPORATION, Kariya-city (JP)

(21) Appl. No.: 19/240,889

(22) Filed: Jun. 17, 2025

Related U.S. Application Data
(63) Continuation of application No. PCT/JP2024/010879, filed on Mar. 20, 2024.

(30) Foreign Application Priority Data
Apr. 14, 2023 (JP) 2023-066664

(51) Int. Cl. H02M 1/44; H02M 1/14; H02M 7/00

(52) U.S. Cl. CPC H02M 1/44; H02M 1/14; H02M 7/003

(57) ABSTRACT

A filter device includes: a magnetic core that is shaped in a ring form and has a through-hole which extends through the magnetic core in an arrangement direction of the first electric component and the second electric component; and a busbar that extends through the through-hole. The busbar has a first electrical connection, a second electrical connection and a coupling portion. One of the first electrical connection and the second electrical connection extends through the through-hole, and an occupying width of the one of the first electrical connection and the second electrical connection measured in a width direction is smaller than a diametrical dimension of the through-hole measured in the width direction. Another occupying width of the one of the first electrical connection and the second electrical connection measured in a thickness direction is smaller than another diametrical dimension of the through-hole measured in the thickness direction.

### CROSS REFERENCE TO RELATED APPLICATIONS

This application is a continuation application of International Patent Application No. PCT/JP2024/010879 filed on Mar. 20, 2024, which designated the U.S. and claims the benefit of priority from Japanese Patent Application No. 2023-066664 filed on Apr. 14, 2023. The entire disclosures of all of the above applications are incorporated herein by reference.

### TECHNICAL FIELD

The present disclosure relates to a filter device.

### BACKGROUND

A previously proposed filter device (also known as a busbar unit) includes a magnetic core and a plurality of busbars. The magnetic core is shaped in a ring form and has a through-hole which extends through the magnetic core. Each of the busbars has a main body portion, an intersecting portion and a folded-back portion. The main body portion is placed in the through-hole. The intersecting portion is placed outside of the through-hole on one side thereof in an axial direction of the through-hole and is bent in an intersecting direction which intersects the axial direction. The folded-back portion is placed outside of the magnetic core and extends in the axial direction toward the other side.

### SUMMARY

According to one aspect of the present disclosure, there is provided a filter device that is configured to be connected to a first electric component and a second electric component and is configured to be placed between the first electric component and the second electric component in an arrangement direction in which the first electric component and the second electric component are arranged. The filter device may include a magnetic core and at least one busbar. The magnetic core may be shaped in a ring form and may have a through-hole which extends through the magnetic core in the arrangement direction. The at least one busbar may be configured to electrically connect between the first electric component and the second electric component and may extend through the through-hole. The at least one busbar may have a first electrical connection, a second electrical connection and a coupling portion. The first electrical connection may be configured to be connected to the first electric component and may extend in the arrangement direction. The second electrical connection may be placed at a location displaced from the first electrical connection in a width direction of the at least one busbar, which is perpendicular to both of the arrangement direction and a thickness direction of the at least one busbar. The second electrical connection may be configured to be connected to the second electric component and may extend in the arrangement direction. The coupling portion may couple between the first electrical connection and the second electrical connection in the arrangement direction. One of the first electrical connection and the second electrical connection may extend through the through-hole. An occupying width of the one of the first electrical connection and the second electrical connection measured in the width direction may be smaller than a diametrical dimension of the through-hole measured in the width direction. Another occupying width of the one of the first electrical connection and the second electrical connection measured in the thickness direction may be smaller than another diametrical dimension of the through-hole measured in the thickness direction.

### BRIEF DESCRIPTION OF DRAWINGS

The drawings described herein are for illustrative purposes only of selected embodiments and not all possible implementations, and are not intended to limit the scope of the present disclosure.

FIG. 1 is an electric circuit diagram of electric components.

FIG. 2 is an exploded perspective view of a filter device.

FIG. 3 is a plan view of the filter device.

FIG. 4 is a view of the filter device taken in a direction of an arrow IV in FIG. 3.

FIG. 5 is a view of the filter device taken in a direction of an arrow V in FIG. 3.

FIG. 6 is a view of the filter device taken in a direction of an arrow VI in FIG. 3.

FIG. 7 is a plan view for explaining a modification of a busbar.

FIG. 8 is a plan view for explaining a modification of busbars.

FIG. 9 is a perspective view for explaining a modification of an arrangement of a magnetic core and busbars.

FIG. 10 is a perspective view for explaining a modification of an arrangement of a magnetic core and busbars.

### DETAILED DESCRIPTION

A previously proposed filter device (also known as a busbar unit) includes a magnetic core and a plurality of busbars. The magnetic core is shaped in a ring form and has a through-hole which extends through the magnetic core. Each of the busbars has a main body portion, an intersecting portion and a folded-back portion. The main body portion is placed in the through-hole. The intersecting portion is placed outside of the through-hole on one side thereof in an axial direction of the through-hole and is bent in an intersecting direction which intersects the axial direction. The folded-back portion is placed outside of the magnetic core and extends in the axial direction toward the other side.

In the previously proposed filter device, a distal end portion, which is connected to a power control unit, is formed at an end portion of the main body portion at each busbar. A distal end portion, which is connected to a corresponding one of phase terminals of a rotary electric machine, is formed at an end portion of the folded-back portion. The filter device is placed between the power control unit and the rotary electric machine. An arrangement direction, in which the power control unit and the rotary electric machine are arranged, is perpendicular to the axial direction of the through-hole. The busbar extends along an inner surface, a lower surface and an outer surface of the magnetic core at a location between the two distal end portions. Therefore, in the previously proposed filter device, there is a concern that an overall size of each busbar may increase in the direction in which the intersecting portion extends, making the filter device larger.

According to the present disclosure, there is provided a filter device that is configured to be connected to a first electric component and a second electric component and is configured to be placed between the first electric component and the second electric component in an arrangement direction in which the first electric component and the second electric component are arranged, the filter device including:
a magnetic core that is shaped in a ring form and has a through-hole which extends through the magnetic core in the arrangement direction; and
at least one busbar that is configured to electrically connect between the first electric component and the second electric component and extends through the through-hole, wherein:
the at least one busbar has:
   a first electrical connection that is configured to be connected to the first electric component and extends in the arrangement direction;
   a second electrical connection that is placed at a location displaced from the first electrical connection in a width direction of the at least one busbar, which is perpendicular to both of the arrangement direction and a thickness direction of the at least one busbar, wherein the second electrical connection is configured to be connected to the second electric component and extends in the arrangement direction; and
   a coupling portion that couples between the first electrical connection and the second electrical connection in the arrangement direction;
one of the first electrical connection and the second electrical connection extends through the through-hole;
an occupying width of the one of the first electrical connection and the second electrical connection measured in the width direction is smaller than a diametrical dimension of the through-hole measured in the width direction; and
another occupying width of the one of the first electrical connection and the second electrical connection measured in the thickness direction is smaller than another diametrical dimension of the through-hole measured in the thickness direction.

The one of the first electrical connection and the second electrical connection, which extends through the through-hole, is placed in a projected area, onto which the magnetic core is projected in the arrangement direction. Accordingly, a size of the at least one busbar can be effectively limited in the width direction, enabling the filter device to be made compact.

Hereinafter, embodiments of the present disclosure will be described with reference to the drawings. In each of the following embodiments, the same reference signs may be assigned to portions that are the same as or equivalent to those described in the preceding embodiment(s), and the description thereof may be omitted. Further, when only a portion of a structure is described in each embodiment, the description of the rest of the structure described in the preceding embodiment may be applied to the rest of the structure.

In addition to the combinations of portions that are specifically shown to be combinable in the respective embodiments, it is also possible to partially combine any two or more of the embodiments and/or modifications even if they are not specifically shown, provided that the combinations are not impeded.

### First Embodiment

### (In-Vehicle System)

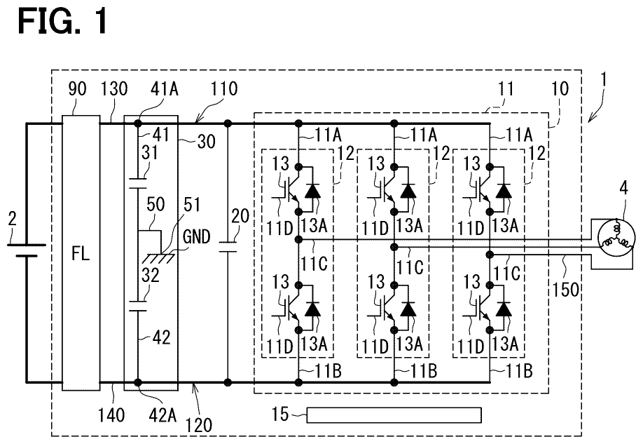

FIG. 1 is an electric circuit diagram of an electric component 10 mounted in an in-vehicle system 1. A battery 2, a motor generator 4, and the electric component 10 are mounted on the in-vehicle system 1. The vehicle, on which the in-vehicle system 1 is mounted, is a hybrid vehicle that is capable of switching between, and/or combining, a drive force of an internal combustion engine and a drive force of the motor generator 4 for traveling. The internal combustion engine and the motor generator 4 are coupled with each other via a gear device.

The electric component 10 includes an inverter 11, a control circuit board 15, a smoothing capacitor 20, a Y-capacitor 30, a filter device 90, a positive side (P-side) wiring 110, a negative-side (N-side) wiring 120 and a plurality (three in this instance) of connection busbars 150. The P-side wiring 110 is an electrical conductive member connected to a positive terminal of the battery 2. The N-side wiring 120 is an electrical conductive member connected to a negative terminal of the battery 2. The connection busbars 150 are electrical conductive members that connect between the inverter 11 and the motor generator 4.

The inverter 11 is connected to the P-side wiring 110 and the N-side wiring 120. The inverter 11 includes a plurality of semiconductor modules 12. Each semiconductor module 12 includes two switching elements 13 and two diodes 13A. The two switching elements 13 are connected in series between the P-side wiring 110 and the N-side wiring 120.

A P-side input terminal 11A, which is connected to the P-side wiring 110, is connected to a collector electrode of one of the two switching elements 13, which is provided on a high-potential side and will be hereinafter referred to as a high-potential side switching element 13. An N-side input terminal 11B, which is connected to the N-side wiring 120, is connected to an emitter of the other one of the two switching elements 13, which is provided on a low-potential side and will be hereinafter referred to as a low-potential side switching element 13. An anode of each diode 13A is connected to the emitter of the corresponding switching element 13. A cathode of each diode 13A is connected to the collector of the corresponding switching element 13.

Each of a plurality of motor terminals 11C connected to the motor generator 4 is connected to both the emitter of the high-potential side switching element 13 and the collector of the low-potential side switching element 13. The switching elements 13 convert the direct-current (DC) power supplied from the battery 2 into alternating-current (AC) power that can drive the motor generator 4. The electric power converted by this power conversion is supplied to the motor generator 4 via the connection busbars 150.

The control circuit board 15 controls turning on and off of the switching elements 13. A control circuit for controlling the turning on and off of the switching elements 13 is mounted on the control circuit board 15. Connection terminals 11D of the switching elements 13 are soldered to the control circuit board 15. The connection terminals 11D of the switching elements 13 are electrically connected to the control circuit board 15.

The smoothing capacitor 20 primarily smooths the DC voltage supplied from the battery 2. The smoothing capacitor 20 is connected to the P-side wiring 110 and the N-side wiring 120. The smoothing capacitor 20 is connected in parallel with the inverter 11. The P-side wiring 110 and the N-side wiring 120 electrically connect the inverter 11, the smoothing capacitor 20 and the battery 2.

The filter device 90 includes a magnetic core 60, a base 70, a plurality of fastener members 80, 81, 82, 83, a P-side busbar 130 and an N-side busbar 140. The P-side busbar 130 is a part of the P-side wiring 110. The P-side busbar 130 may be referred to as a first busbar. The N-side busbar 140 is a part of the N-side wiring 120. The N-side busbar 140 may be referred to as a second busbar. The P-side busbar 130 and the N-side busbar 140 may collectively be referred to as P- and N-busbars 130, 140. The magnetic core 60 is provided around the P-side busbar 130 and the N-side busbar 140.

The magnetic core 60 includes a magnetic core main body 61 and an engaging portion 62. The magnetic core main body 61 is shaped in a ring form. The magnetic core main body 61, which is shaped in the ring form, forms a through-hole 63 that extends through the magnetic core main body 61 in one direction. The P-side busbar 130 and the N-side busbar 140 extend through the through-hole 63. The magnetic core 60 can remove noise components induced by the electric current flowing through the P-side busbar 130 and the N-side busbar 140. For this reason, the device, which includes the magnetic core 60, may be referred to as the filter device 90. Examples of a main material (magnetic material) for the magnetic core main body 61 include ferrite, electromagnetic steel sheets, and amorphous metals. The magnetic material is sealed with an insulating member. The magnetic material is sealed with the insulating member to form the magnetic core main body 61.

The engaging portion 62 is provided on an outer periphery of the magnetic core main body 61. The engaging portion 62 extends away from the magnetic core main body 61 in a direction perpendicular the one direction. The engaging portion 62 is an anchoring portion for installing the magnetic core main body 61 to the base 70. The magnetic core main body 61 is fixed to the base 70 by attaching the engaging portion 62 to the base 70 using the fastener member 80.

The Y-capacitor 30 mainly removes noise components, which leak from the inverter 11. The Y-capacitor 30 includes two capacitor elements 31, 32, two Y-capacitor busbars 41, 42 and a ground busbar 50. One of the two capacitor elements 31, 32, which is positioned on the P-side wiring 110 side, may be referred to as a P-side capacitor element 31. The other one of the two capacitor elements 31, 32, which is positioned on the N-side wiring 120 side, may be referred to as an N-side capacitor element 32.

One of the two Y-capacitor busbars 41, 42, which is connected to the P-side capacitor element 31, may be referred to as a P-side Y-capacitor busbar 41. The P-side Y-capacitor busbar 41 may be referred to as a first capacitor busbar. The P-side Y-capacitor busbar 41 includes: a P-side first busbar terminal 41A, which is connected to the P-side capacitor element 31; and a P-side second busbar terminal, which is connected to the P-side wiring 110. The P-side capacitor element 31 is electrically connected to the P-side wiring 110 through the P-side Y-capacitor busbar 41.

The other one of the two Y-capacitor busbars 41, 42, which is connected to the N-side capacitor element 32, may be referred to as an N-side Y-capacitor busbar 42. The N-side Y-capacitor busbar 42 may be referred to as a second capacitor busbar. The N-side Y-capacitor busbar 42 includes: an N-side first busbar terminal 42A, which is connected to the N-side capacitor element 32; and an N-side second busbar terminal, which is connected to the N-side wiring 120. The N-side capacitor element 32 is electrically connected to the N-side wiring 120 through the N-side Y-capacitor busbar 42.

The ground busbar 50 includes: a P-side GND terminal, which is connected to the P-side capacitor element 31; an N-side GND terminal, which is connected to the N-side capacitor element 32; and a ground terminal 51, which is connected to the ground through the base 70. The ground busbar 50 extends so as to connect the P-side GND terminal, the N-side GND terminal and the ground terminal 51. The ground busbar 50 is connected to the capacitor elements 31, 32 and is also electrically connected to the ground.

The ground busbar 50 is electrically connected to a body ground such as a chassis through the base 70. The capacitor elements 31, 32 remove noise components from the inverter 11 by directing the noise components leaked from the inverter 11 to the body ground through the ground busbar 50. Furthermore, the capacitor elements 31, 32 can remove not only the noise components leaking from the inverter 11 but also noise components flowing through the P-side busbar 130 and the N-side busbar 140.

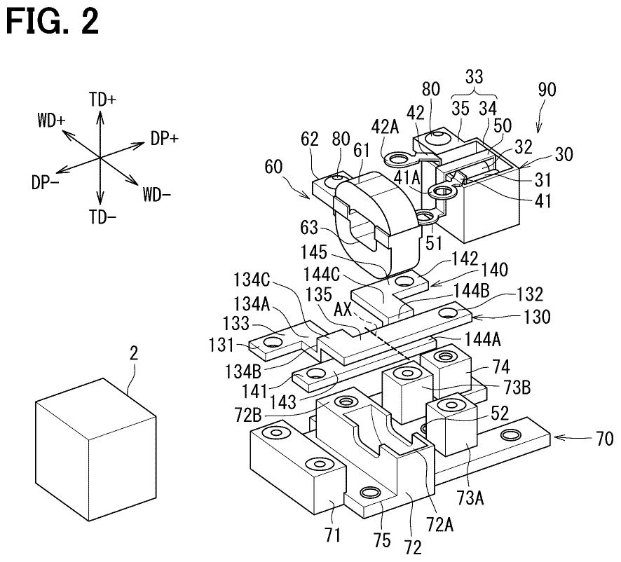

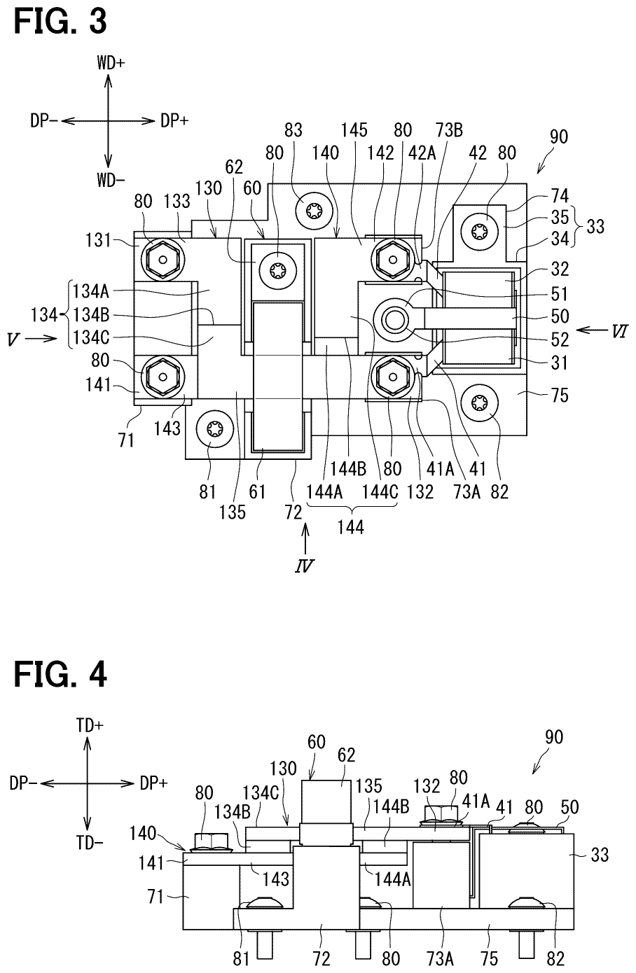

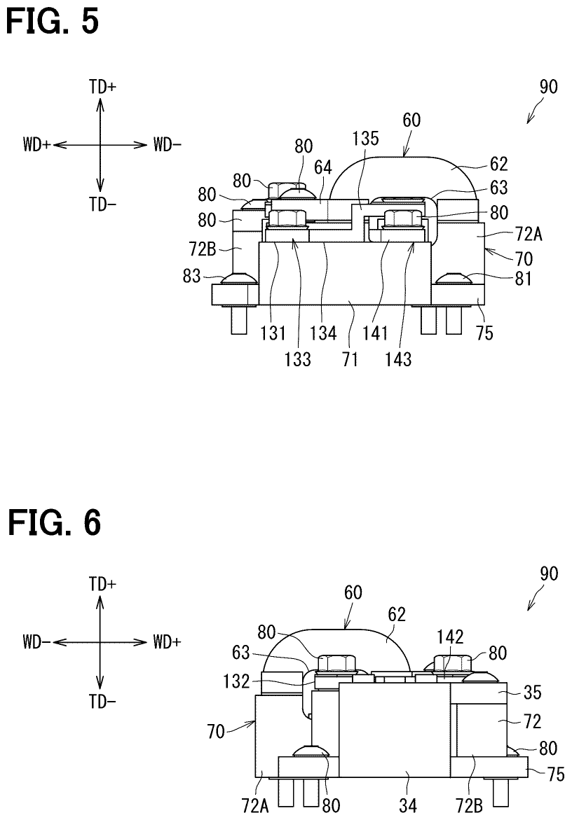

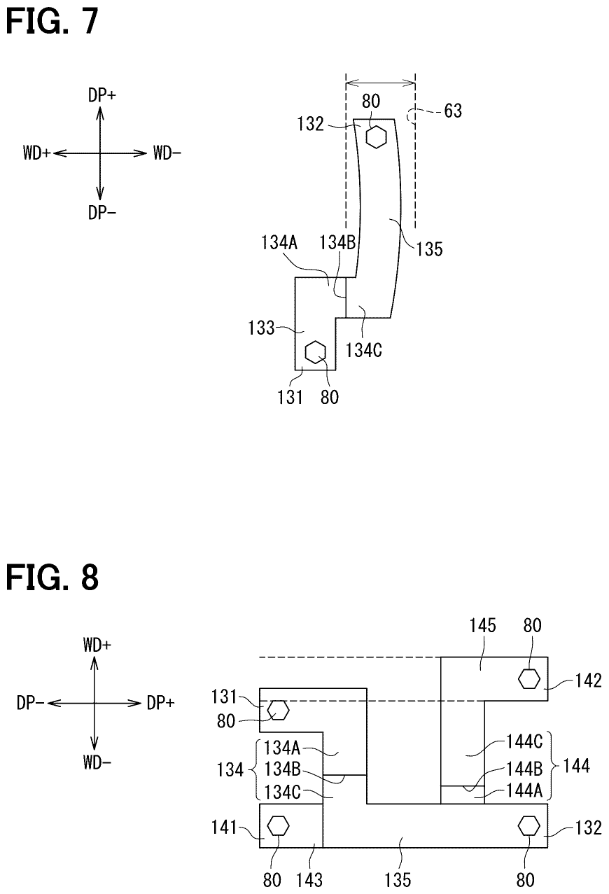

FIG. 2 is an exploded perspective view of the filter device 90. FIG. 3 is a plan view of the filter device 90. FIG. 4 is a view of the filter device 90 taken in a direction of an arrow IV in FIG. 3. FIG. 5 is a view of the filter device 90 taken in a direction of an arrow V in FIG. 3. FIG. 6 is a view of the filter device 90 taken in a direction of an arrow VI in FIG. 3. FIG. 7 is a plan view for explaining a modification of the busbar 130, 140. A thickness direction of each of the P-side busbar 130 and the N-side busbar 140 may be referred to as a thickness direction TD. A direction perpendicular to the thickness direction TD may be referred to as a depth direction DP. A direction perpendicular to both the thickness direction TD and the depth direction DP may be referred to as a width direction WD. The thickness direction TD, the depth direction DP and the width direction WD are three directions that are perpendicular to each other.

The P-side busbar 130 and the N-side busbar 140 electrically connect between the battery 2 and the Y-capacitor 30. Each of the P-side busbar 130 and the N-side busbar 140 extends along the depth direction DP while being partially bent in the width direction WD. Each of the P-side busbar 130 and the N-side busbar 140 has a stepped shape with a single step. The battery 2 and the Y-capacitor 30 are arranged one after another in the depth direction DP. The P-side busbar 130 and the N-side busbar 140 are provided between the battery 2 and the Y-capacitor 30 in the depth direction DP that is an arrangement direction, in which the battery 2 and the Y-capacitor 30 are arranged. The battery 2 may be referred to as a first electric component. The Y-capacitor 30 may be referred to as a second electric component.

A first terminal 131, 141, which is connected to the battery 2, is formed at one end of each of the P-side busbar 130 and the N-side busbar 140, which faces in the depth direction DP. A second terminal 132, 142, which is connected to the Y-capacitor 30, is formed at the other end of each of the P-side busbar 130 and the N-side busbar 140, which faces in the depth direction DP. The first terminal 131 of the P-side busbar 130 may be referred to as a P-side first terminal 131. The second terminal 132 of the P-side busbar 130 may be referred to as a P-side second terminal 132.

### (P-Side Busbar)

The P-side busbar 130 has a first extension 133, a second extension 134 and a third extension 135. The first extension 133 and the third extension 135 are arranged apart from each other in the width direction WD. The first extension 133 is placed on a far side (which will be hereinafter referred to as a width direction far side) WD+ of the third extension 135 in the width direction WD. The third extension 135 is placed on a near side (which will be hereinafter referred to as a width direction near side) WD− of the first extension 133 in the width direction WD.

The first extension 133 and the third extension 135 extend along the depth direction DP. The first extension 133 is placed on a near side (which will be hereinafter referred to as a depth direction near side) DP− of the third extension 135 in the depth direction DP. The third extension 135 is placed on a far side (which will be hereinafter referred to as a depth direction far side) DP+ of the first extension 133 in the depth direction DP. The P-side first terminal 131 is formed at an end of the first extension 133, which faces the depth direction near side DP−. The P-side second terminal 132 is formed at an end of the third extension 135, which faces the depth direction far side DP+.

The second extension 134 is formed such that the second extension 134 couples between an end of the first extension 133, which is opposite to the P-side first terminal 131, and an end of the third extension 135, which is opposite to the P-side second terminal 132. The second extension 134 may be referred to as a coupling portion. The second extension 134 is located between the first extension 133 and the third extension 135 in the depth direction DP. The second extension 134 is located between the first extension 133 and the third extension 135 in the width direction WD. The second extension 134 extends in the width direction WD when the second extension 134 is viewed in the thickness direction TD. An angle defined between the first extension 133 and the second extension 134 is a right angle or a substantially right angle. An angle defined between the third extension 135 and the second extension 134 is a right angle or a substantially right angle. The P-side busbar 130 is shaped in a crank form when the P-side busbar 130 is viewed in the thickness direction TD.

The second extension 134 has three extension pieces 134A, 134B, 134C. These three extension pieces 134A, 134B, 134C may be referred to as a P-side first extension piece 134A, a P-side second extension piece 134B and a P-side third extension piece 134C, respectively. The P-side first extension piece 134A is coupled to the end of the first extension 133, which is opposite to the P-side first terminal 131. The P-side first extension piece 134A extends from the first extension 133 toward the third extension 135 in the width direction WD.

Furthermore, a position of the first extension 133 in the thickness direction TD is different from a position of the third extension 135 in the thickness direction TD. The P-side third extension piece 134C is coupled to the end of the third extension 135, which is opposite to the P-side second terminal 132. The P-side third extension piece 134C extends from the third extension 135 toward the first extension 133 in the width direction WD.

The P-side second extension piece 134B is formed such that the P-side second extension piece 134B couples between the P-side first extension piece 134A and the P-side third extension piece 134C. The P-side second extension piece 134B extends in the thickness direction TD. The P-side first extension piece 134A, the P-side second extension piece 134B and the P-side third extension piece 134C are formed continuously one after another. The P-side first extension piece 134A, the P-side second extension piece 134B and the P-side third extension piece 134C form the stepped shape with the single step. A lower side of this stepped shape on the thickness direction lower side TD− may be referred to as a lower tier. An upper side of this stepped shape on the thickness direction upper side TD+ may be referred to as an upper tier. The first extension 133 and the P-side first extension piece 134A are formed at the lower tier. The third extension 135 and the P-side third extension piece 134C are formed at the upper tier. The P-side second extension piece 134B is formed such that the P-side second extension piece 134B couples between the upper tier and the lower tier.

The magnetic core main body 61 is shaped in the ring form around the axis extending in the depth direction DP. The magnetic core main body 61 has the through-hole 63, which extends through the magnetic core main body 61 in the depth direction DP at the inside of the ring of the magnetic core main body 61. The third extension 135 extends through the through-hole 63. An occupying width of the third extension 135 measured in the width direction WD is smaller than a diametrical dimension of the through-hole 63 measured in the width direction WD. Another occupying width of the third extension 135 measured in the thickness direction TD is smaller than another diametrical dimension of the through-hole 63 measured in the thickness direction TD. Furthermore, the second extension 134 is placed in a projected area, onto which the magnetic core 60 is projected in the depth direction DP. Here, the term “diametrical dimension” refers to a dimension of the through-hole 63 measured in a specific direction such as the width direction WD or the thickness direction TD, regardless of whether the through-hole 63 has a circular, rectangular, oblong shape, or the like.

The occupying width of the third extension 135 measured in the width direction WD is equal to a distance between a point of the third extension 135, which is located farthest on the width direction far side DP+, and another point of the third extension 135, which is located farthest on the width direction near side WD−. The occupying width of the third extension 135 measured in the width direction WD may be referred to as a physical size of the third extension 135 measured in the width direction WD. The other occupying width of the third extension 135 measured in the thickness direction TD is equal to a distance between a point of the third extension 135, which is located farthest on the thickness direction upper side TD+, and another point of the third extension 135, which is located farthest on the thickness direction lower side TD−. The other occupying width of the third extension 135 measured in the thickness direction TD may be referred to as a physical size of the third extension 135 measured in the thickness direction.

Furthermore, a length of the third extension 135 measured in the depth direction DP is longer than a length of the through-hole 63 measured in the depth direction DP. The length of the third extension 135 measured in the depth direction DP is longer than the diametrical dimension of the through-hole 63 measured in the width direction WD and the length of the through-hole 63 measured in the depth direction DP. The magnetic core main body 61 is placed at a center portion of the third extension 135, which is centered in the depth direction DP. The center portion of the third extension 135, which is centered in the depth direction DP, is received through the through-hole 63.

In the first embodiment, the third extension 135 extends in the one direction along the depth direction DP. However, the third extension 135 may not extend in the one direction along the depth direction DP. For example, as shown in FIG. 7, the third extension 135 may extend in the depth direction DP while being curved in the width direction WD. Although not illustrated in the drawing, the third extension 135 may extend in the depth direction DP while being curved in the thickness direction TD. Even in such a case, the occupying width of the third extension 135 measured in the width direction WD is smaller than the diametrical dimension of the through-hole 63 measured in the width direction WD. The other occupying width of the third extension 135 measured in the thickness direction TD is smaller than the other diametrical dimension of the through-hole 63 measured in the thickness direction TD.

### (N-Side Busbar)

The N-side busbar 140 has a fourth extension 143, a fifth extension 144 and a sixth extension 145. The fourth extension 143 and the sixth extension 145 are arranged apart from each other in the width direction WD. The fourth extension 143 is placed on the width direction near side WD− of the sixth extension 145. The sixth extension 145 is placed on the width direction far side DP+ of the fourth extension 143.

The fourth extension 143 and the sixth extension 145 extend along the depth direction DP. The fourth extension 143 is placed on the depth direction near side DP− of the sixth extension 145. The sixth extension 145 is placed on the depth direction far side DP+ of the fourth extension 143. The N-side first terminal 141 is formed at an end of the fourth extension 143, which faces the depth direction near side DP−. The N-side second terminal 142 is formed at an end of the sixth extension 145, which faces the depth direction far side DP+.

The fifth extension 144 is formed such that the fifth extension 144 couples between an end of the fourth extension 143, which is opposite to the N-side first terminal 141, and an end of the sixth extension 145, which is opposite to the N-side second terminal 142. The fifth extension 144 may be referred to as a coupling portion. The fifth extension 144 is located between the fourth extension 143 and the sixth extension 145 in the depth direction DP. The fifth extension 144 is located between the fourth extension 143 and the sixth extension 145 in the width direction WD. The fifth extension 144 extends in the width direction WD when the fifth extension 144 is viewed in the thickness direction TD. An angle defined between the fourth extension 143 and the fifth extension 144 is a right angle or a substantially right angle. An angle defined between the sixth extension 145 and the fifth extension 144 is a right angle or a substantially right angle. The N-side busbar 140 is shaped in a crank form when the N-side busbar 140 is viewed in the thickness direction TD.

The fifth extension 144 has three extension pieces 144A, 144B, 144C. These three extension pieces 144A, 144B, 144C may be referred to as an N-side first extension piece 144A, an N-side second extension piece 144B and an N-side third extension piece 144C, respectively. The N-side first extension piece 144A is coupled to the end of the fourth extension 143, which is opposite to the N-side first terminal 141. The N-side first extension piece 144A extends from the fourth extension 143 toward the sixth extension 145 in the width direction WD.

Furthermore, a position of the fourth extension 143 in the thickness direction TD is different from a position of the sixth extension 145 in the thickness direction TD. The N-side third extension piece 144C is coupled to an end of the sixth extension 145, which is opposite to the N-side second terminal 142. The N-side third extension piece 144C extends from the sixth extension 145 toward the fourth extension 143 in the width direction WD.

The N-side second extension piece 144B is formed such that the N-side second extension piece 144B couples between the N-side first extension piece 144A and the N-side third extension piece 144C. The N-side second extension piece 144B extends in the thickness direction TD. The N-side first extension piece 144A, the N-side second extension piece 144B and the N-side third extension piece 144C are formed continuously one after another. The N-side first extension piece 144A, the N-side second extension piece 144B and the N-side third extension piece 144C form the stepped shape with the single step. The fourth extension 143 and the N-side first extension piece 144A are formed at a lower tier of this stepped shape. The sixth extension 145 and the N-side third extension piece 144C are formed at an upper tier of this stepped shape. The N-side second extension piece 144B is formed such that the N-side second extension piece 144B couples between the upper tier and the lower tier.

As described above, the magnetic core main body 61 has the through-hole 63, which extends through the magnetic core main body 61 in the depth direction DP at the inside of the ring of the magnetic core main body 61. The fourth extension 143 extends through the through-hole 63. An occupying width of the fourth extension 143 measured in the width direction WD is smaller than the diametrical dimension of the through-hole 63 measured in the width direction WD. Another occupying width of the fourth extension 143 measured in the thickness direction TD is smaller than the other diametrical dimension of the through-hole 63 measured in the thickness direction TD. The fifth extension 144 is placed in a projected area, onto which the magnetic core 60 is projected in the depth direction DP.

The occupying width of the fourth extension 143 measured in the width direction WD is equal to a distance between a point of the fourth extension 143, which is located farthest on the width direction far side WD+, and another point of the fourth extension 143, which is located farthest on the width direction near side WD−. The occupying width of the fourth extension 143 measured in the width direction WD may be referred to as a physical size of the fourth extension 143 measured in the width direction WD. The other occupying width of the fourth extension 143 measured in the thickness direction TD is equal to a distance between a point of the fourth extension 143, which is located farthest on the thickness direction upper side TD+, and another point of the fourth extension 143, which is located farthest on the thickness direction lower side TD−. The other occupying width of the fourth extension 143 measured in the thickness direction TD may be referred to as a physical size of the fourth extension 143 measured in the thickness direction TD.

In the first embodiment, the fourth extension 143 extends in the one direction along the depth direction DP. However, the fourth extension 143 may not extend in the one direction along the depth direction DP. For example, the fourth extension 143 may extend in the depth direction DP while being curved in the width direction WD. The fourth extension 143 may extend in the depth direction DP while being curved in the thickness direction TD. Even in such a case, the occupying width of the fourth extension 143 measured in the width direction WD is smaller than the diametrical dimension of the through-hole 63 measured in the width direction WD. The other occupying width of the fourth extension 143 measured in the thickness direction TD is smaller than the other diametrical dimension of the through-hole 63 measured in the thickness direction TD.

Furthermore, a length of the fourth extension 143 measured in the depth direction DP is larger than the length of the through-hole 63 measured in the depth direction DP. The length of the fourth extension 143 measured in the depth direction DP is larger than the diametrical dimension of the through-hole 63 measured in the width direction WD and the length of the through-hole 63 measured in the depth direction DP. The magnetic core main body 61 is placed at a center portion of the fourth extension 143, which is centered in the depth direction DP. The center portion of the fourth extension 143, which is centered in the depth direction DP, is received through the through-hole 63.

In the first embodiment, the fourth extension 143 extends in the one direction along the depth direction DP. However, the fourth extension 143 may not extend in the one direction along the depth direction DP. For example, the fourth extension 143 may extend in the depth direction DP while being curved in the width direction WD. The fourth extension 143 may extend in the depth direction DP while being curved in the thickness direction TD. Even in such a case, the occupying width of the fourth extension 143 measured in the width direction WD is smaller than the diametrical dimension of the through-hole 63 measured in the width direction WD. The other occupying width of the fourth extension 143 measured in the thickness direction TD is smaller than the other diametrical dimension of the through-hole 63 measured in the thickness direction TD.

### (P-Side Busbar and N-Side Busbar)

A virtual axis AX is defined as an axis extending in the width direction WD and passing through the center point between the first terminal 131, 141 and the second terminal 132, 142 in the depth direction DP. The N-side busbar 140 is obtained by rotating the P-side busbar 130 by 180 degrees around the virtual axis AX. In other words, the N-side busbar 140 is a flipped version of the P-side busbar 130. The P-side busbar 130 and the N-side busbar 140 have the identical shape but are flipped relative to each other. The first extension 133 of the P-side busbar 130 and the sixth extension 145 of the N-side busbar 140 have the identical shape. The second extension 134 of the P-side busbar 130 and the fifth extension 144 of the N-side busbar 140 have the identical shape. The third extension 135 of the P-side busbar 130 and the fourth extension 143 of the N-side busbar 140 have the identical shape.

The third extension 135 is formed at the width direction near side WD− in the P-side busbar 130. The first extension 133 is formed at the width direction far side WD+ in the P-side busbar 130. The fourth extension 143 is formed at the width direction near side WD− in the N-side busbar 140. The sixth extension 145 is formed at the width direction far side WD+ in the N-side busbar 140. The third extension 135 and the fourth extension 143 overlap with each other in the thickness direction TD. The third extension 135 is placed on the thickness direction upper side TD+ of the fourth extension 143. A position of the first extension 133 in the thickness direction TD is the same as a position of the fourth extension 143 in the thickness direction TD. The first extension 133 and the fourth extension 143 are spaced apart from each other in the width direction WD by a distance sufficient to maintain electrical insulation therebetween. The first extension 133 and the fourth extension 143 overlap with each other in the width direction WD. A position of the third extension 135 in the thickness direction TD is the same as a position of the sixth extension 145 in the thickness direction TD. The third extension 135 and the sixth extension 145 are spaced apart from each other in the width direction WD by a distance sufficient to maintain electrical insulation therebetween. The third extension 135 and the sixth extension 145 overlap with each other in the width direction WD.

The second extension 134 extends in a stepped shape from the width direction far side WD+ toward the width direction near side WD− such that a portion of the second extension 134 is raised one step from the thickness direction lower side TD− toward the thickness direction upper side TD+. The P-side second extension piece 134B overlaps with the fourth extension 143 in the width direction WD. The P-side second extension piece 134B is placed on the width direction far side WD+ of the fourth extension 143. The P-side third extension piece 134C overlaps with the fourth extension 143 in the thickness direction TD. The P-side third extension piece 134C is placed on the thickness direction upper side TD+ of the fourth extension 143.

Similarly, the fifth extension 144 extends in a stepped shape from the width direction near side WD− toward the width direction far side WD+ such that a portion of the fifth extension 144 is raised one step from the thickness direction lower side TD− toward the thickness direction upper side TD+. The N-side first extension piece 144A overlaps with the third extension 135 in the thickness direction TD. The N-side second extension piece 144B overlaps with the third extension 135 in the width direction WD. The N-side first extension piece 144A is placed on the thickness direction lower side TD− of the third extension 135.

Furthermore, the P-side first extension piece 134A and the N-side third extension piece 144C are spaced apart from each other in the depth direction DP. A separation distance between the P-side first extension piece 134A and the N-side third extension piece 144C is larger than a thickness of the magnetic core main body 61 measured in the depth direction DP. The magnetic core main body 61 is placed between the P-side first extension piece 134A and the N-side third extension piece 144C. The third extension 135 and the fourth extension 143 extend through the through-hole 63 of the magnetic core main body 61. The magnetic core main body 61 extends in the ring form around the axis extending in the depth direction DP to surround the third extension 135 and the fourth extension 143. The engaging portion 62 is placed on the width direction far side WD+ of the magnetic core main body 61. The engaging portion 62 extends away from the magnetic core main body 61 toward the width direction far side WD+.

The P-side busbar 130, the N-side busbar 140, the magnetic core 60 and the Y-capacitor 30 are fixed to the base 70. The base 70 is fixed to, for example, a housing that receives the power module. The base 70 has a first terminal fixing portion 71, a magnetic body fixing portion 72, a second terminal fixing portion 73, a Y-capacitor fixing portion 74 and a pedestal 75. The pedestal 75 is shaped in a plate form with a relatively small thickness in the thickness direction TD. The first terminal fixing portion 71, the magnetic body fixing portion 72, the second terminal fixing portion 73 and the Y-capacitor fixing portion 74 project from the pedestal 75 toward the thickness direction upper side TD+. The first terminal fixing portion 71 may be referred to as a first fixing portion. The second terminal fixing portion 73 may be referred to as a second fixing portion.

The first terminal fixing portion 71 is a fixing portion to which the P-side first terminal 131 and the N-side first terminal 141 are fixed. The first terminal fixing portion 71 has a plurality (two in this instance) of holes, into which the fastener members 80 for fixing the P-side first terminal 131 and the N-side first terminal 141 are respectively inserted. The P-side first terminal 131 and the N-side first terminal 141 are fixed to the first terminal fixing portion 71 via the fastener members 80. A separation distance between the two holes is equal to a distance between the first extension 133 and the fourth extension 143. Here, the first extension 133 and the fourth extension 143 are portions connected to the battery 2, which serves as the first electric component, and therefore each of the first extension 133 and the fourth extension 143 may be referred to as a first electrical connection.

The magnetic body fixing portion 72 receives a portion of the magnetic core main body 61 and has the engaging portion 62 fixed thereto. The magnetic body fixing portion 72 has: a receiving portion 72A, which receives the portion of the magnetic core main body 61 facing the thickness direction lower side TD−; and a fixing portion 72B, to which the engaging portion 62 is fixed. The fixing portion 72B has a hole which receives the fastener member 80 that fixes the engaging portion 62 to the fixing portion 72B. The engaging portion 62 is fixed to the fixing portion 72B via the fastener member 80. The engaging portion 62 is fixed to the fixing portion 72B via the fastener member 80 in an overlapping area where a projected area, onto which the second extension 134 is projected in the depth direction DP, overlaps with a projected area, onto which the fifth extension 144 is projected in the depth direction DP.

The second terminal fixing portion 73 has a P-side second terminal fixing portion 73A and an N-side second terminal fixing portion 73B. The P-side second terminal fixing portion 73A is a fixing portion to which the P-side second terminal 132 is fixed. The P-side second terminal fixing portion 73A may be referred to as a first-busbar-side second fixing portion. The P-side second terminal fixing portion 73A has a hole, into which the fastener member 80 for fixing the P-side second terminal 132 is inserted. The P-side second terminal 132 is fixed to the P-side second terminal fixing portion 73A via the fastener member 80.

The N-side second terminal fixing portion 73B is a fixing portion to which the N-side second terminal 142 is fixed. The N-side second terminal fixing portion 73B may be referred to as a second-busbar-side second fixing portion. The N-side second terminal fixing portion 73B has a hole, into which the fastener member 80 for fixing the N-side second terminal 142 is inserted. The N-side second terminal 142 is fixed to the N-side second terminal fixing portion 73B via the fastener member 80. Here, the third extension 135 and the sixth extension 145 are portions connected to the Y-capacitor 30, which serves as the second electric component, and therefore each of the third extension 135 and the sixth extension 145 may be referred to as a second electrical connection.

The Y-capacitor fixing portion 74 has a hole, into which the fastener member 80 for fixing the Y-capacitor 30 is inserted. The N-side second terminal 142 is fixed to the N-side second terminal fixing portion 73B via the fastener member 80. The P-side second terminal fixing portion 73A and the N-side second terminal fixing portion 73B are spaced apart from each other in the width direction WD. A separation distance between the P-side second terminal fixing portion 73A and the N-side second terminal fixing portion 73B is equal to a distance between the third extension 135 and the sixth extension 145. The Y-capacitor fixing portion 74 overlaps with the N-side second terminal fixing portion 73B in the depth direction DP.

The Y-capacitor fixing portion 74 is a fixing portion, to which the Y-capacitor 30 is fixed. The Y-capacitor fixing portion 74 has the hole, into which the fastener member 80 for fixing the Y-capacitor 30 is inserted. The Y-capacitor 30 is fixed to the Y-capacitor fixing portion 74 via the fastener member 80.

The four fixing portions 71 to 74 are arranged in the order of the first terminal fixing portion 71, the magnetic body fixing portion 72, the second terminal fixing portion 73 and the Y-capacitor fixing portion 74 from the depth direction near side DP− toward the depth direction far side DP+. The first terminal fixing portion 71 and the magnetic body fixing portion 72 are spaced apart from each other in the depth direction DP by a distance approximately equal to the width of the second extension 134. The magnetic body fixing portion 72 and the second terminal fixing portion 73 are spaced apart from each other in the depth direction DP by a distance approximately equal to the width of the fifth extension 144. A position of an upper end surface of the first terminal fixing portion 71 in the thickness direction TD is different from a position of an upper end surface of the second terminal fixing portion 73 in the thickness direction TD. The position of the upper end surface of the first terminal fixing portion 71 in the thickness direction TD is a position where the first extension 133 and the fourth extension 143 can be fixed. The position of the upper end surface of the second terminal fixing portion 73 in the thickness direction TD is a position where the third extension 135 and the sixth extension 145 can be fixed. The upper end surface of the first terminal fixing portion 71 is placed on the thickness direction lower side TD− of the upper end surface of the second terminal fixing portion 73. The upper end surface of the second terminal fixing portion 73 is placed on the thickness direction upper side TD+ of the upper end surface of the first terminal fixing portion 71.

The third extension 135 of the P-side busbar 130 is inserted through the through-hole 63 of the magnetic core main body 61. The second extension 134 extends between the first terminal fixing portion 71 and the magnetic body fixing portion 72. The second extension 134 overlaps with the magnetic core main body 61 in the depth direction DP. The P-side first terminal 131 is fixed to the first terminal fixing portion 71. The P-side second terminal 132 is fixed to the P-side second terminal fixing portion 73A.

The fourth extension 143 of the N-side busbar 140 is inserted through the through-hole 63 of the magnetic core main body 61. The fifth extension 144 extends between the magnetic body fixing portion 72 and the second terminal fixing portion 73. The fifth extension 144 overlaps with the magnetic core main body 61 in the depth direction DP. The N-side first terminal 141 is fixed to the first terminal fixing portion 71. The N-side second terminal 142 is fixed to the N-side second terminal fixing portion 73B.

The Y-capacitor 30 is placed adjacent to the Y-capacitor fixing portion 74 in the width direction WD. The Y-capacitor 30 includes a capacitor case 33 besides the capacitor elements 31, 32, the capacitor busbars 41, 42 and the ground busbar 50. The capacitor case 33 has: a receiving portion 34, which receives these components; and an engaging portion 35, which is fixed to the Y-capacitor fixing portion 74. The engaging portion 35 is fixed to the Y-capacitor fixing portion 74 via the fastener member 80.

Portions of the capacitor busbars 41, 42 and a portion of the ground busbar 50 are exposed from the receiving portion 34 on the depth direction near side DP− of the receiving portion 34. The P-side first busbar terminal 41A, the N-side first busbar terminal 42A and the ground terminal 51 are exposed from the receiving portion 34. The P-side first busbar terminal 41A and the N-side first busbar terminal 42A are spaced apart from each other in the width direction WD. The P-side first busbar terminal 41A is placed on the width direction near side WD− of the N-side first busbar terminal 42A. The ground terminal 51 is placed between the P-side first busbar terminal 41A and the N-side first busbar terminal 42A in the width direction WD.

The P-side second terminal 132 and the P-side first busbar terminal 41A are fastened together to the P-side second terminal fixing portion 73A via the fastener member 80. The P-side second terminal 132 and the P-side first busbar terminal 41A are electrically and mechanically coupled to each other via the fastener member 80. The N-side second terminal 142 and the N-side first busbar terminal 42A are fastened together to the N-side second terminal fixing portion 73B via the fastener member 80. The N-side second terminal 142 and the N-side second terminal fixing portion 73B are electrically and mechanically coupled to each other via the fastener member 80.

A ground terminal fixing portion 52, which can be connected to the body ground via the fastener member 80, is provided at a location between the P-side second terminal fixing portion 73A and the N-side second terminal fixing portion 73B in the pedestal 75. The ground terminal 51 is electrically and mechanically coupled to the ground terminal fixing portion 52 via the fastener member 80. The P-side capacitor element 31 and the N-side capacitor element 32 are electrically connected to the ground.

Furthermore, the fastener members 81, 82, 83 for installing the base 70 to, for example, the housing of the power module (serving as an external portion) are installed on the pedestal 75. The fastener member 81 is placed in an overlapping area where a projected area, onto which the second extension 134 is projected in the width direction WD, overlaps with a projected area, onto which the magnetic core main body 61 is projected in the depth direction DP. The fastener member 82 is placed in an overlapping area where a projected area, onto which the third extension 135 is projected in the depth direction DP, overlaps with a projected area, onto which the Y-capacitor 30 is projected in the width direction WD. A fastener member 83 is placed in an overlapping area where a projected area, onto which the magnetic core main body 61 and the fifth extension 144 are projected in the width direction WD, overlaps with a projected area, onto which the engaging portion 35 is projected in the depth direction DP.

Note that the fastener members 81, 82, 83 may be referred separately from the fastener members 80. The fastener members 81, 82, 83 may be referred to be primary fastener members. The fastener members 80 may be referred to be secondary fastener members.

### (Manufacturing Method of Filter Device)

Next, a manufacturing method of the filter device 90 will be described. First, the base 70 is prepared. Next, the magnetic core main body 61 is placed in the receiving portion 72A of the magnetic body fixing portion 72. Next, the fourth extension 143 is inserted along the depth direction DP into the through-hole 63 from the depth direction far side DP+ toward the depth direction near side DP−. Next, the third extension 135 is inserted along the depth direction DP into the through-hole 63 from the depth direction near side DP− toward the depth direction far side DP+. The third extension 135 is inserted along the depth direction DP into the through-hole 63 such that the third extension 135 overlaps the fourth extension 143 on the thickness direction upper side TD+ of the fourth extension 143.

Note that the order of insertion of the fourth extension 143 and the third extension 135 into the through-hole 63 is not limited to the above-described order. The third extension 135 may be inserted into the through-hole 63 before the fourth extension 143. In that case, the fourth extension 143 is inserted along the depth direction DP into the through-hole 63 such that the fourth extension 143 overlaps the third extension 135 on the thickness direction lower side TD− of the third extension 135.

Next, the Y-capacitor 30 is fixed to the Y-capacitor fixing portion 74. The Y-capacitor 30 is fixed to the Y-capacitor fixing portion 74 such that the first busbar terminals 41A, 42A overlap the second terminals 132, 142 in the thickness direction TD, and the ground terminal 51 overlaps the ground terminal fixing portion 52 in the thickness direction TD. Each of the first busbar terminals 41A, 42A is fixed to the corresponding one of the second terminals 132, 142 via the corresponding fastener member 80. The ground terminal 51 is fixed to the ground terminal fixing portion 52 via the fastener member 80. The base 70 is fixed to the housing of, for example, the power module via the fastener members 81, 82, 83.

### Actions and Advantages

The filter device 90 is electrically connected to the battery 2 and the Y-capacitor 30. The battery 2 and the Y-capacitor 30 are arranged one after another in the depth direction DP. The filter device 90 is placed between the battery 2 and the Y-capacitor 30 in the depth direction DP. The filter device 90 includes the magnetic core 60 and the busbars 130, 140. The magnetic core main body 61 of the magnetic core 60 is shaped in the ring form around the axis extending in the depth direction DP. The magnetic core main body 61, which is shaped in the ring form, forms the through-hole 63 that extends through the magnetic core main body 61 in the depth direction DP. The P-side busbar 130 has the first extension 133, the second extension 134 and the third extension 135. The N-side busbar 140 has the fourth extension 143, the fifth extension 144 and the sixth extension 145.

The first extension 133 and the fourth extension 143 are connected to the battery 2 and extend in the depth direction DP. The third extension 135 and the sixth extension 145 are connected to the Y-capacitor 30 and extend in the depth direction DP. The second extension 134 couples between the first extension 133 and the third extension 135. The fifth extension 144 couples between the fourth extension 143 and the sixth extension 145. The third extension 135 of the P-side busbar 130 extends through the through-hole 63. The fourth extension 143 of the N-side busbar 140 extends through the through-hole 63.

The third extension 135 and the fourth extension 143 extend through the through-hole 63, and the occupying width of the third extension 135 or the fourth extension 143 measured in the width direction WD is smaller than the diametrical dimension of the through-hole 63 measured in the width direction WD. The other occupying width of the third extension 135 or the fourth extension 143 measured in the thickness direction TD is smaller than the other diametrical dimension of the through-hole 63 measured in the thickness direction TD. The third extension 135 or the fourth extension 143, which extends through the through-hole 63, is placed in a projected area, onto which the magnetic core 60 is projected in the depth direction DP. Accordingly, the size of the busbars 130, 140 can be effectively limited, enabling the filter device 90 to be made compact.

Furthermore, at the time of the manufacturing, either the third extension 135 or the fourth extension 143 is inserted into the through-hole 63 along the depth direction DP. As described above, the occupying width of the third extension 135 or the fourth extension 143 measured in the width direction WD and the occupying width of the third extension 135 or the fourth extension 143 measured in the thickness direction TD are respectively smaller than the diametrical dimension of the through-hole 63 measured in the width direction WD and the other diametrical dimension of the through-hole 63 measured in the thickness direction TD. For this reason, an assembly worker can smoothly insert the third extension 135 or the fourth extension 143 into the through-hole 63 without twisting it. This makes it possible to provide the filter device 90 with improved assemblability.

The second extension 134 and the fifth extension 144 extend in the width direction WD when the second extension 134 and the fifth extension 144 are viewed in the thickness direction TD. The first extension 133 and the second extension 134 define the substantially right angle therebetween, and the second extension 134 and the third extension 135 define the substantially right angle therebetween. The fourth extension 143 and the fifth extension 144 define the substantially right angle therebetween, and the fifth extension 144 and the sixth extension 145 define the substantially right angle therebetween. Compared to a case in which the corresponding extensions are connected in a curved manner rather than forming the substantially right angles, an increase in the size of the busbars 130, 140 in the depth direction DP is suppressed. The second extension 134 is placed in a projected area, onto which the magnetic core 60 is projected in the depth direction DP, and the fifth extension 144 is placed in another projected area, onto which the magnetic core 60 is projected in the depth direction DP. An increase in the size of the busbars 130, 140 in the width direction WD is suppressed. An increase in the size of the filter device 90 can be suppressed.

The busbars 130, 140 include the P-side busbar 130 and the N-side busbar 140. The third extension 135 of the P-side busbar 130 and the fourth extension 143 of the N-side busbar 140 extend through the through-hole 63. The third extension 135 and the fourth extension 143 overlap with each other in the thickness direction TD. According to this, compared to an exemplary configuration in which the third extension 135 and the fourth extension 143 do not overlap with each other in the thickness direction TD, the magnetic core 60 having a smaller diametrical dimension of the through-hole 63 measured in the width direction WD can be applied. The size of the filter device 90 can be reduced.

The P-side busbar 130 and the N-side busbar 140 are arranged such that the third extension 135 of the P-side busbar 130 and the fourth extension 143 of the N-side busbar 140 overlap with each other in the thickness direction TD. The P-side first terminal 131 of the first extension 133 and the N-side first terminal 141 of the fourth extension 143 overlap with each other in the width direction WD. The P-side second terminal 132 of the third extension 135 and the N-side second terminal 142 of the sixth extension 145 overlap with each other in the width direction WD. The N-side busbar 140 has a shape identical to that of the P-side busbar 130 when the P-side busbar 130 is rotated by 180 degrees around the virtual axis AX. Since the P-side busbar 130 and the N-side busbar 140 are mirror images of each other with respect to their front and back sides, the same design can be applied to both. As discussed above, the third extension 135 of the P-side busbar 130 and the fourth extension 143 of the N-side busbar 140 overlap with each other in the thickness direction TD, and each terminal 131, 132 of the P-side busbar 130 and the corresponding terminal 141, 142 of the N-side busbar 140 overlap with each other in the width direction WD, so that an increase in an occupied volume, which is occupied by the P-side busbar 130 and the N-side busbar 140, is suppressed.

The second extension 134 has the stepped shape that rises by the one step from the thickness direction lower side TD− toward the thickness direction upper side TD+. The second extension 134 has the stepped shape that rises by the one step from the thickness direction lower side TD− toward the thickness direction upper side TD+. The base 70 has the first terminal fixing portion 71, to which the P-side first terminal 131 of the first extension 133 and the N-side first terminal 141 of the fourth extension 143 are fixed.

The base 70 also has the second terminal fixing portion 73, to which the P-side second terminal 132 of the third extension 135 and the N-side second terminal 142 of the sixth extension 145 are fixed. The position of the first extension 133 in the thickness direction TD is the same as the position of the fourth extension 143 in the thickness direction TD. The position of the third extension 135 in the thickness direction TD is the same as the position of the sixth extension 145 in the thickness direction TD. According to this, since the position of the P-side first terminal 131 and the position of the N-side first terminal 141 in the thickness direction TD are the same, the P-side first terminal 131 and the N-side first terminal 141 can be easily fixed to the first terminal fixing portion 71. Since the position of the P-side second terminal 132 and the position of the N-side second terminal 142 in the thickness direction TD are the same, the P-side second terminal 132 and the N-side second terminal 142 can be easily fixed to the second terminal fixing portion 73. The assemblability of the busbars 130, 140 with the base 70 is improved.

The Y-capacitor 30 includes the capacitor elements 31, 32, the P-side Y-capacitor busbar 41, the N-side Y-capacitor busbar 42 and the ground busbar 50. The P-side Y-capacitor busbar 41 has the P-side first busbar terminal 41A, which is connected to the P-side second terminal 132 of the third extension 135. The N-side Y-capacitor busbar 42 has the N-side first busbar terminal 42A, which is connected to the N-side second terminal 142 of the sixth extension 145. The ground busbar 50 connects the capacitor elements 31, 32 to the ground. Furthermore, the ground busbar 50 has the ground terminal 51, which is formed at the end portion of the ground busbar 50 that is different from the other end portion of the ground busbar 50 connected to the capacitor elements 31, 32.

The second terminal fixing portion 73 has the P-side second terminal fixing portion 73A and the N-side second terminal fixing portion 73B. The base 70 also has the ground terminal fixing portion 52, which is located between the P-side second terminal fixing portion 73A and the N-side second terminal fixing portion 73B and to which the ground terminal 51 is fixed. The P-side second terminal fixing portion 73A and the N-side second terminal fixing portion 73B are spaced apart from each other by a distance that is sufficient to maintain electrical insulation between the P-side second terminal 132 and the N-side second terminal 142. The gap between the P-side second terminal fixing portion 73A and the N-side second terminal fixing portion 73B is a necessary gap from a design perspective.

The ground terminal fixing portion 52 is placed in this gap. Therefore, this gap is not left as a dead space. Since the dead space can be utilized, it is unnecessary to provide a portion for fixing the ground terminal 51 at a location other than this gap in the base 70. With this configuration, an increase in the size of the filter device 90 can be suppressed.

The filter device 90 includes the fastener members 81, 82, 83 for installing the base 70 to the external portion. The base 70 also has: the magnetic body fixing portion 72, to which the magnetic core 60 is fixed; and the Y-capacitor fixing portion 74, to which the Y-capacitor 30 is fixed. A projected area, onto which one of the magnetic core 60, the busbars 130, 140 and the Y-capacitor 30 is projected in the width direction WD or the depth direction DP, is referred to as a first projected area. A projected area, onto which another one of the magnetic core 60, the busbars 130, 140 and the Y-capacitor 30 is projected in the width direction WD or the depth direction DP, is referred to as a second projected area. At least a portion of each of the fastener members 81, 82, 83 is placed in an overlapping area where the corresponding first projected area overlaps with the corresponding second projected area. With this configuration, it is unnecessary to provide, at the base 70, a space other than the above-described portions for fixing the fastener members 81, 82, 83. Therefore, an increase in the size of the filter device 90 can be suppressed.

The second extension 134 and the fifth extension 144 are spaced apart from each other in the depth direction DP. The fastener member 80, which fixes the magnetic core 60 to the magnetic body fixing portion 72, is placed in the overlapping area where the projected area, onto which the second extension 134 is projected in the depth direction DP, overlaps with the projected area, onto which the fifth extension 144 is projected in the depth direction DP. The gap between the second extension 134 and the fifth extension 144 is a necessary gap from a design perspective. The magnetic body fixing portion 72 is placed in this gap. Therefore, this gap is not left as a dead space. Since the dead space can be utilized, it is unnecessary to provide, at the base 70, a space for fixing the magnetic body fixing portion 72 at a location other than this gap.

### Other Embodiments

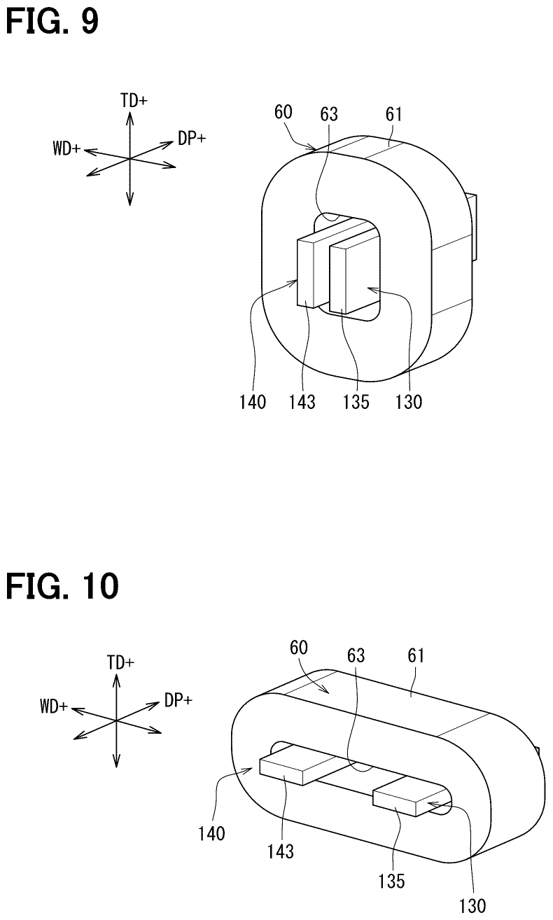

FIG. 8 is a plan view for explaining a modification of the busbars 130, 140. FIG. 9 is a perspective view for explaining a modification of the arrangement of the magnetic core 60 and the busbars 130, 140. FIG. 10 is a perspective view for explaining a modification of the arrangement of the magnetic core 60 and the busbars 130, 140.

In the first embodiment, it is explained that the P-side busbar 130 and the N-side busbar 140 have the identical shape but are flipped relative to each other. However, the P-side busbar 130 and the N-side busbar 140 do not necessarily have to have the identical shape. The shape of the P-side busbar 130 and the shape of the N-side busbar 140 may be partially different from each other. As one example, in the configuration where the P-side first terminal 131 and the N-side second terminal 142 at least partially overlap each other in the depth direction DP, the length of the fifth extension 144 in the width direction WD may be larger than that of the second extension 134.

In the first embodiment, it is explained that the third extension 135 and the fourth extension 143 overlap with each other in the thickness direction TD and extend through the through-hole 63. However, the third extension 135 and the fourth extension 143 do not necessarily have to overlap with each other in the thickness direction TD and extend through the through-hole 63. As one example, the third extension 135 and the fourth extension 143 may overlap with each other in the width direction WD and extend through the through-hole 63. Furthermore, as shown in FIG. 9, the third extension 135 and the fourth extension 143 may extend through the through-hole 63 in a state where a main surface of the third extension 135 and a main surface of the fourth extension 143 overlap with each other in the width direction WD. Also, as shown in FIG. 10, the third extension 135 and the fourth extension 143 may extend through the through-hole 63 in a state where a lateral surface of the third extension 135 and a lateral surface of the fourth extension 143 overlap with each other in the width direction WD.

Furthermore, in the first embodiment, it is explained that the third extension 135 of the P-side busbar 130 and the fourth extension 143 of the N-side busbar 140 both extend through the through-hole 63. Alternatively, only one of the P-side busbar 130 and the N-side busbar 140 may extend through the through-hole 63. In a case where only the P-side busbar 130 extends through the through-hole 63, the third extension 135 extends through the through-hole 63. In a case where only the N-side busbar 140 extends through the through-hole 63, the fourth extension 143 extends through the through-hole 63.

Although the present disclosure has been described with reference to the embodiments, it should be understood that the present disclosure is not limited to the embodiments and the structures described therein. The present disclosure also includes various variations and variations within the equivalent range. In addition, the various combinations and forms are shown in this disclosure. However, other combinations and forms including only one element, more or less, are also within the scope and idea of the present disclosure.

What is claimed is:

1. A filter device that is configured to be connected to a first electric component and a second electric component and is configured to be placed between the first electric component and the second electric component in an arrangement direction in which the first electric component and the second electric component are arranged, the filter device comprising:
a magnetic core that is shaped in a ring form and has a through-hole which extends through the magnetic core in the arrangement direction; and
at least one busbar that is configured to electrically connect between the first electric component and the second electric component and extends through the through-hole, wherein:
the at least one busbar has:
a first electrical connection that is configured to be connected to the first electric component and extends in the arrangement direction;
a second electrical connection that is placed at a location displaced from the first electrical connection in a width direction of the at least one busbar, which is perpendicular to both of the arrangement direction and a thickness direction of the at least one busbar, wherein the second electrical connection is configured to be connected to the second electric component and extends in the arrangement direction; and
a coupling portion that couples between the first electrical connection and the second electrical connection in the arrangement direction;
one of the first electrical connection and the second electrical connection extends through the through-hole;
an occupying width of the one of the first electrical connection and the second electrical connection measured in the width direction is smaller than a diametrical dimension of the through-hole measured in the width direction; and
another occupying width of the one of the first electrical connection and the second electrical connection measured in the thickness direction is smaller than another diametrical dimension of the through-hole measured in the thickness direction.

2. The filter device according to claim 1, wherein the coupling portion extends in the width direction in a view taken in the thickness direction.

3. The filter device according to claim 2, wherein the coupling portion is placed in a projected area, onto which the magnetic core is projected in the arrangement direction.

4. The filter device according to claim 1, wherein:
the at least one busbar is two busbars;
a first busbar, which is one of the two busbars, has: a first extension, which forms the first electrical connection; a second extension, which forms the coupling portion; and a third extension, which forms the second electrical connection;
a second busbar, which is another one of the two busbars, has: a fourth extension, which forms the first electrical connection; a fifth extension, which forms the coupling portion; and a sixth extension, which forms the second electrical connection;
the third extension and the fourth extension extend through the through-hole; and
the third extension and the fourth extension overlap with each other in the thickness direction or the width direction.

5. The filter device according to claim 4, wherein:
the first busbar and the second busbar are arranged in a state where the third extension and the fourth extension overlap with each other in the thickness direction;
the first extension and the fourth extension overlap with each other in the width direction; and
the third extension and the sixth extension overlap with each other in the width direction.

6. The filter device according to claim 5, comprising a base that has: a first fixing portion, to which the first extension and the fourth extension are fixed; and a second fixing portion, to which the third extension and the sixth extension are fixed, wherein:
each of the second extension and the fifth extension has a stepped shape which is shaped such that a position of the first extension in the thickness direction is the same as a position of the fourth extension in the thickness direction, and a position of the third extension in the thickness direction is the same as a position of the sixth extension in the thickness direction.

7. The filter device according to claim 6, wherein:
the second electric component is a Y-capacitor;
the Y-capacitor includes: at least one capacitor element; a first capacitor busbar, which is configured to be connected to the at least one capacitor element and the third extension; a second capacitor busbar, which is configured to be connected to the at least one capacitor element and the sixth extension; and a ground busbar, which is configured to connect between the at least one capacitor element and a ground;
the second fixing portion has: a first-busbar-side second fixing portion, to which the third extension and the first capacitor busbar are fixed; and a second-busbar-side second fixing portion, to which the sixth extension and the second capacitor busbar are fixed; and
the ground busbar is connected to a portion of the base located between the first-busbar-side second fixing portion and the second-busbar-side second fixing portion.

8. The filter device according to claim 7, wherein:
the base has: a magnetic body fixing portion, to which the magnetic core is fixed; and a Y-capacitor fixing portion, to which the Y-capacitor is fixed; and
at least a portion of a fastener member, which is configured to install the base to an external portion, is placed in an overlapping area where a projected area, onto which one of the magnetic core, the first busbar, the second busbar and the Y-capacitor is projected in the arrangement direction or the width direction, overlaps with a projected area, onto which another one of the magnetic core, the first busbar, the second busbar and the Y-capacitor is projected in the arrangement direction or the width direction.

9. The filter device according to claim 8, wherein:
the second extension and the fifth extension are spaced from each other in the arrangement direction; and
the fastener member is a primary fastener member, and a secondary fastener member, which is different from the primary fastener member and is configured to fix the magnetic core to the magnetic body fixing portion, is placed in an overlapping area where a projected area, onto which the second extension is projected in the arrangement direction, overlaps with a projected area, onto which the fifth extension is projected in the arrangement direction.
